(19) United States
(12) Patent Application Publication
(10) Pub. No.: US 2011/0141422 A1
(43) Pub. Date: Jun. 16, 2011

(54) LIQUID CRYSTAL DISPLAY DEVICE

(76) Inventor: Risuke Yanagawa, Osaka (JP)

(21) Appl. No.: 13/059,525

(22) PCT Filed: Aug. 11, 2009
(86) PCT No.: PCT/JP2009/003854

§ 371 Date: Feb. 17, 2011

(30) Foreign Application Priority Data
Aug. 19, 2008 (JP) 2008-211004

(51) Int. Cl. G02F 1/1343

(52) U.S. Cl. 349/139

(57) ABSTRACT

A liquid crystal display device (100) according to the present invention includes: a first substrate (110) having a first electrode (114); a second substrate (120) having a second electrode (124); and a liquid crystal layer (130) provided between the first electrode (114) and the second electrode (124). The first electrode (114) includes a plurality of metal wires (114m) extending linearly and in parallel to one another. Preferably, the first electrode (114) further includes an outer edge portion (114s) which is continuous with each of the plurality of metal wires (114m).

### TECHNICAL FIELD

The present invention relates to a liquid crystal display device.

### BACKGROUND ART

Liquid crystal display devices have advantages such as light weight, thinness, and low power consumption, and are utilized for the display sections of television sets, computers, mobile terminals, and the like. A generic liquid crystal display device includes two polarizing plates which oppose each other with a liquid crystal layer interposed therebetween, such that the luminance of each pixel changes through adjustment of a voltage applied across the liquid crystal layer.

Commonly-used polarizing plates are formed by, after allowing dichroic iodine to be adsorbed onto a polyvinyl alcohol (PVA) film, drawing it in one direction in order to align the molecules in one orientation. A polarizing plate transmits a polarization component having a polarization direction which is parallel to the transmission axis, and absorbs a polarization component having a polarization direction which is orthogonal to the transmission axis. Such a polarizing plate does not have sufficient thermal resistance, and may deteriorate with ultraviolet.

As another type of polarizing plate, wire grids are known, which have excellent thermal resistance (see Patent Documents 1 to 3). A wire grid has a plurality of metal wires arranged at an equal interval, and a polarization component whose polarization direction is perpendicular to the direction that the metal wires extend (longitudinal direction) is transmitted through the wire grid, whereas a polarization component whose polarization direction is parallel to the longitudinal direction of the metal wires is reflected by the wire grid.

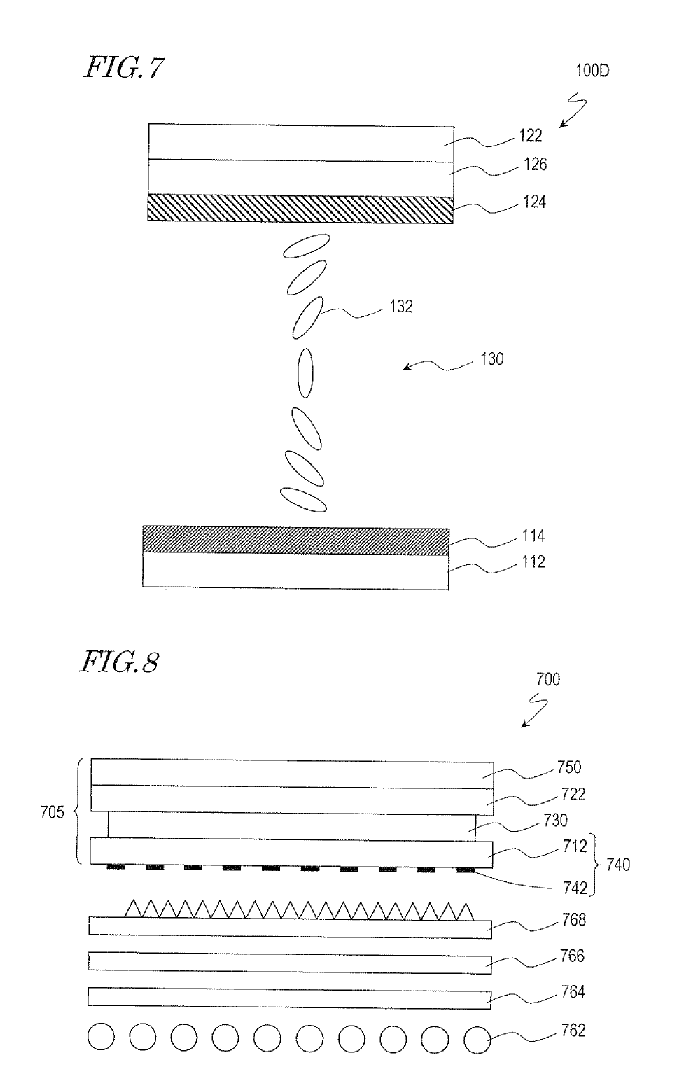

FIG. 8 shows a schematic diagram of a liquid crystal display device 700 disclosed in Patent Document 1. A liquid crystal panel 705 of the liquid crystal display device 700 includes transparent substrates 712 and 722 and a liquid crystal layer 730 provided between the transparent substrate 712 and the transparent substrate 722. On the inside of the transparent substrate 712, electrodes, an alignment film, and the like (not shown) are provided, whereas metal wires 742 are provided on the outside of the transparent substrate 712. A wire grid 740 functioning as a polarizer is composed of the transparent substrate 712 and the metal wires 742. On the inside of the transparent substrate 722, electrodes, an alignment film, and the like (not shown) are provided, whereas a polarizing plate 750 is provided on the outside of the transparent substrate 722.

Light going out from a fluorescent lamp 762 is diffused by a white scattering plate 764, and thereafter its diffusion angle is constricted by a bead scattering plate 766. A prism sheet 768 restricts light so as to be within a specific angle. Such light enters the wire grid 740. Within this light, a polarization component whose polarization direction is perpendicular to the direction (longitudinal direction) that the metal wires 742 extend is transmitted through the wire grid 740. Note that the transmission axis of the wire grid 740 is disposed orthogonal to the transmission axis of the polarizing plate 750. The liquid crystal display device 700 is of a normally black mode, such that linearly polarized light which is transmitted through the wire grid 740 has its polarization direction rotated when a pixel is in an OFF displaying state, whereby the color of that pixel is exhibited through the polarizing plate 750. On the other hand, when a pixel is in an ON displaying state, the polarization direction is kept intact and thus receives blocking by the polarizing plate 750, whereby black is displayed.

On the other hand, a polarization component whose polarization direction is parallel to the direction that the metal wires 742 extend is reflected by the wire grid 740. As the component reflected by the wire grid 740 is reflected by the scattering plates 766 and 764 and a reflector (not shown) which is provided near the fluorescent lamp 762, it undergoes a change in polarization state, and thus enters the wire grid 740 again. Within the light entering the wire grid 740 again, the component whose polarization direction is perpendicular to the direction that the metal wires 742 extend is transmitted through the wire grid 740. Theoretically, such transmission and reflection are repeated an infinite number of times. In the liquid crystal display device 700, most of the light which has been emitted from the fluorescent lamp 762 is finally transmitted through the wire grid 740 via such optical paths. Therefore, the efficiency of light utilization is considerably increased, thus enabling bright displaying with a small power.

However, generally speaking, electrically conductive members such as electrodes and wiring lines and an alignment film and the like are provided on the inside of the transparent substrate 712, and an increase in cost would be induced by separately attaching the metal wires 742 on the outside of the transparent substrate 712, for example. Therefore, a possibility of forming the wire grid on the inside of the transparent substrate together with the other members has been studied (see Patent Documents 2 and 3).

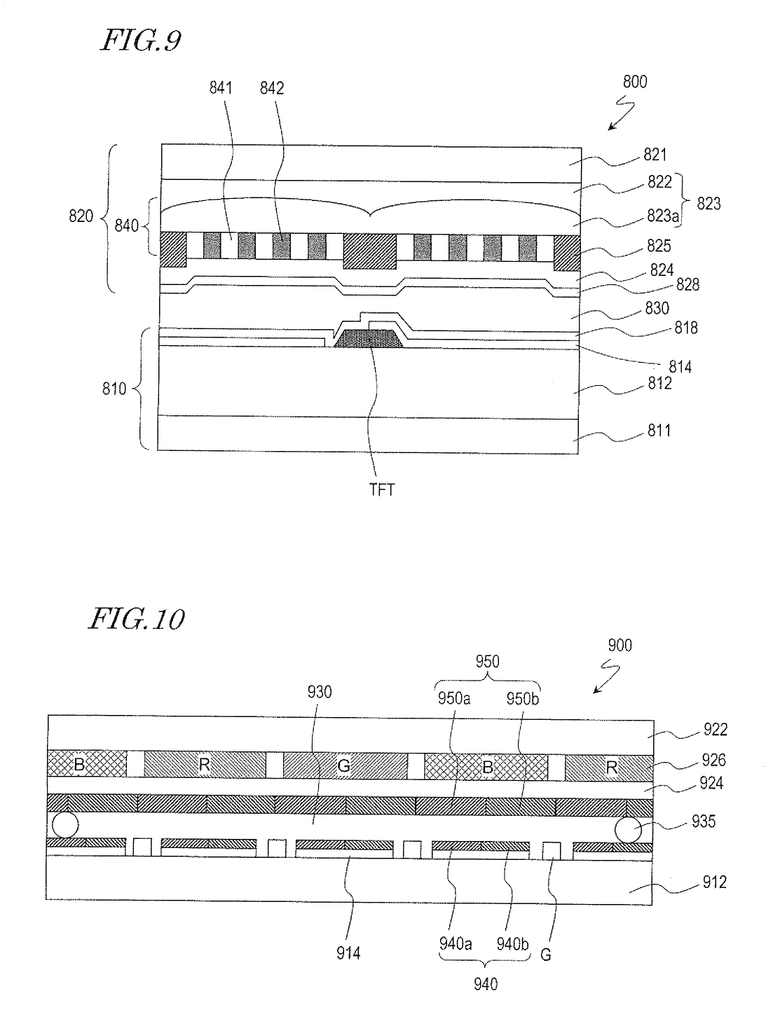

FIG. 9 shows a schematic diagram of a liquid crystal display device 800 disclosed in Patent Document 2. The liquid crystal display device 800 includes a TFT substrate 810, a counter substrate 820, and a liquid crystal layer 830 provided between the TFT substrate 810 and the counter substrate 820. On the counter substrate 820 has a microlens array 823 including a quartz substrate 822 and lens portions 823a. Moreover, the counter substrate 820 has a wire grid 840 including the lens portions 823a and grid portions 842. Thus, the wire grid 840 is integrated with the microlens array 823. Moreover, a counter electrode 824 is provided on the wire grid 840 and a light shielding film 825.

FIG. 10 shows a schematic diagram of a liquid crystal display device 900 disclosed in Patent Document 3. The liquid crystal display device 900 includes a transparent substrate 912, a transparent substrate 922, and a liquid crystal layer 930 provided between the transparent substrate 912 and the transparent substrate 922. A wire grid 940 is provided on pixel electrodes 914. The wire grid 940 has regions 940a and 940b in which metal wires extend in directions which are 90° apart. In the liquid crystal display device 900, the wire grid 940 is formed after forming the pixel electrodes 914 by a known method. The pixel electrodes 914 are formed by depositing a transparent electrically conductive material and thereafter patterning it, for example. Thereafter, the wire grid 940 is formed by vapor-depositing chromium on the pixel electrodes 914 and patterning it in the form of a grating.

Moreover, a wire grid 950 is provided on a counter electrode 924. The wire grid 950 has regions 950a and 950b in which metal wires extend in directions which are 90° apart. The regions 950a of the wire grid 950 oppose the regions 940a of the wire grid 940, such that the directions in which the metal wires extend differ by 90° between the regions 940a and 950a, and similarly, the regions 950b of the wire grid 950 oppose the regions 940b of the wire grid 940, such that the directions in which the metal wires extend differ by 90° between the regions 940b and 950b. The counter electrode 924 is formed by depositing a transparent electrically conductive material and thereafter patterning it, for example. By subsequently vapor-depositing chromium on the counter electrode 924 and patterning it in the form of a grating, the wire grid 950 is formed.

### Citation List

### Patent Literature

[Patent Document 1] Japanese Laid-Open Patent Publication No. 2006-47829

[Patent Document 2] Japanese Laid-Open Patent Publication No. 2007-171802

[Patent Document 3] Japanese Laid-Open Patent Publication No. 9-160013

### SUMMARY OF INVENTION

### Technical Problem

In the liquid crystal display device 800 of Patent Document 2, after forming the wire grid 840 functioning as a polarizer, the counter electrode 824 must be separately formed. In the liquid crystal display device 900 of Patent Document 3, after forming the pixel electrodes 914 and the counter electrode 924, the wire grids 940 and 950 must be separately formed.

The present invention has been made in view of the above problems, and an objective thereof is to provide a liquid crystal display device which can be easily produced.

### Solution to Problem

A liquid crystal display device according to the present invention is a liquid crystal display device comprising: a first substrate having a first electrode; a second substrate having a second electrode; and a liquid crystal layer provided between the first electrode and the second electrode, wherein, at least one of the first electrode and the second electrode includes a plurality of metal wires extending linearly and in parallel to one another.

In one embodiment, the at least one electrode further includes an outer edge portion which is continuous with each of the plurality of metal wires.

In one embodiment, the plurality of metal wires have a pitch of 300 nm or less; a ratio of a width of the plurality of metal wires to the pitch of the plurality of metal wires is in the range from 0.1 to 0.75; and the plurality of metal wires have a height in the range from 50 nm to 500 nm.

In one embodiment, each of the first electrode and the second electrode includes a plurality of metal wires extending linearly and in parallel to one another.

In one embodiment, a direction that the plurality of metal wires of the first electrode extend is orthogonal to a direction that the plurality of metal wires of the second electrode extend.

### Advantageous Effects of Invention

According to the present invention, a liquid crystal display device which can be easily produced is provided.

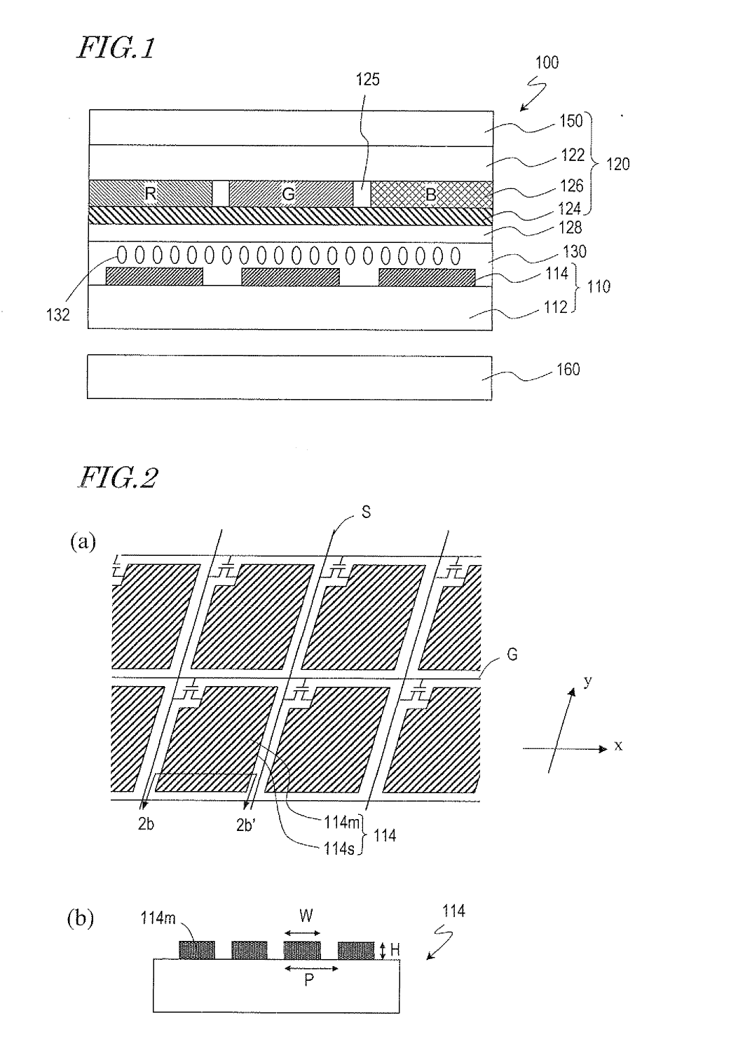

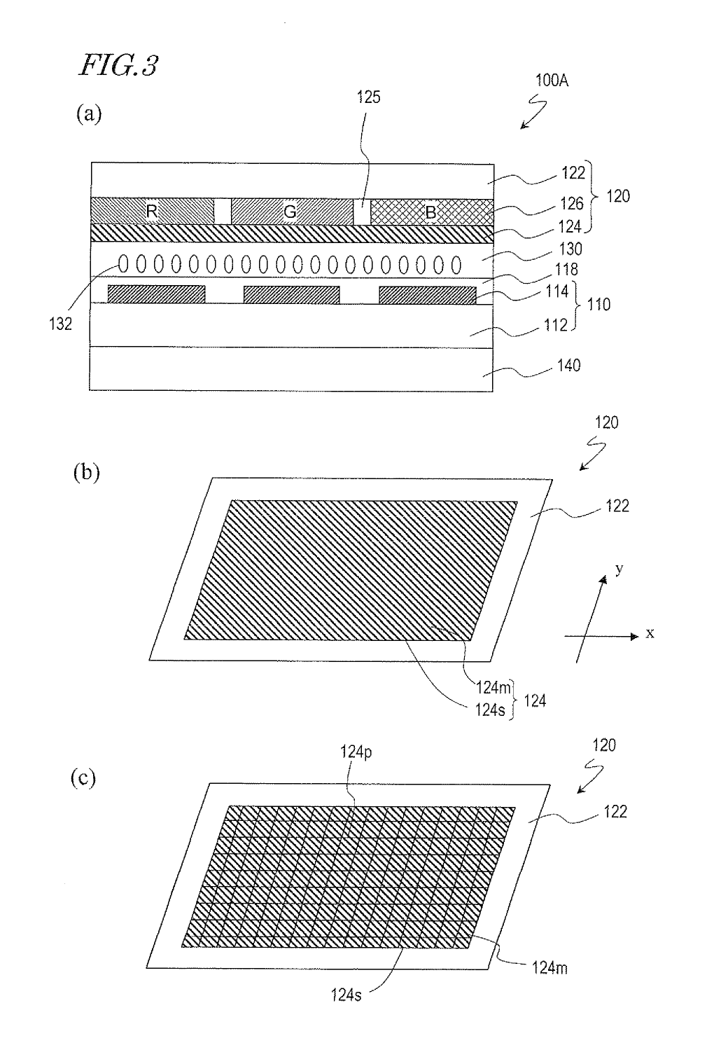

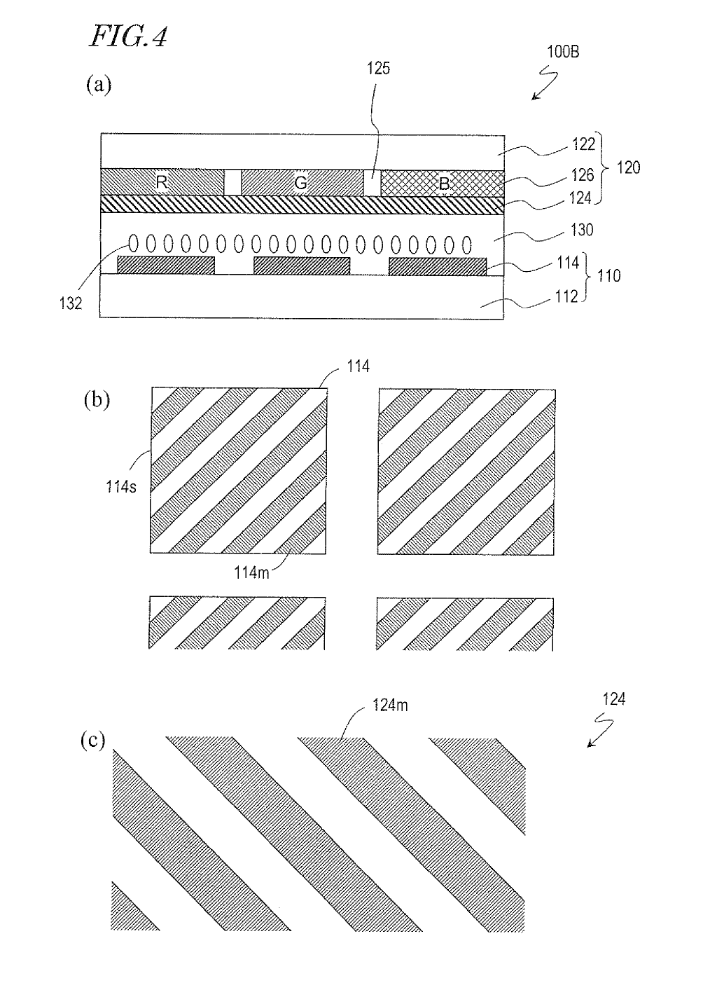

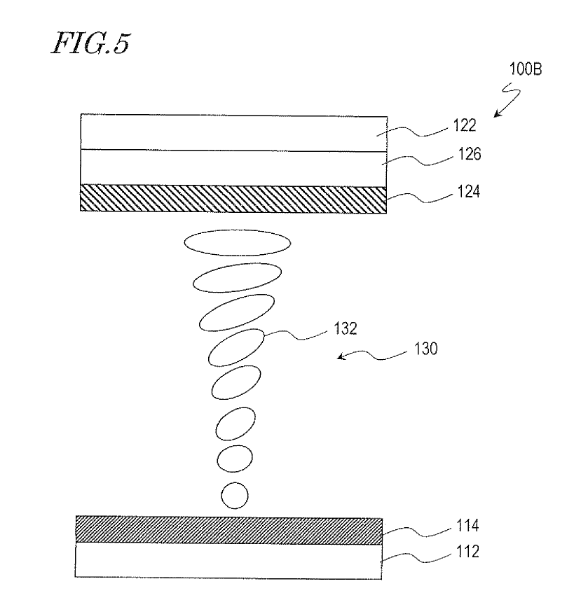

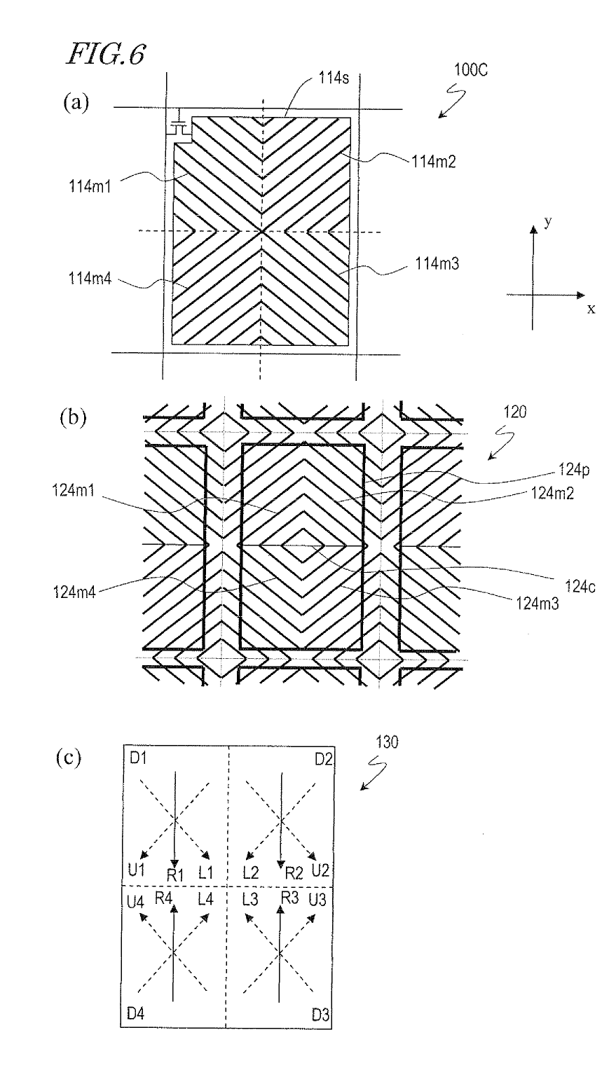

### BRIEF DESCRIPTION OF DRAWINGS

[FIG. 1] A schematic diagram showing an embodiment of a liquid crystal display device according to the present invention.

[FIG. 2] (a) is a schematic perspective view of an active matrix substrate of the liquid crystal display device shown in FIG. 1, and (b) is a schematic cross-sectional view of the active matrix substrate of the liquid crystal display device shown in FIG. 1.

[FIG. 3] (a) is a schematic diagram showing another embodiment of the liquid crystal display device according to the present invention; (b) is a schematic plan view of a counter electrode of the liquid crystal display device shown in (a); and (c) is a schematic plan view of the counter electrode in another form.

[FIG. 4] (a) is a schematic diagram showing another embodiment of the liquid crystal display device according to the present invention; (b) is a schematic plan view of pixel electrodes of the liquid crystal display device shown in (a); and (c) is a schematic plan view of a counter electrode of the liquid crystal display device shown in (a).

[FIG. 5] A schematic diagram showing the liquid crystal display device shown in FIG. 4.

[FIG. 6] A schematic diagram showing another embodiment of the liquid crystal display device according to the present invention, where (a) is a schematic diagram showing a pixel electrode; (b) is a schematic diagram showing a counter electrode; and (c) is a schematic diagram showing reference orientation azimuth directions of liquid crystal domains.

[FIG. 7] A schematic diagram showing another embodiment of the liquid crystal display device according to the present invention.

[FIG. 8] A schematic diagram showing a conventional liquid crystal display device.

[FIG. 9] A schematic diagram showing a conventional liquid crystal display device.

[FIG. 10] A schematic diagram showing a conventional liquid crystal display device.

### DESCRIPTION OF EMBODIMENTS

Hereinafter, with reference to the drawings, embodiments of the liquid crystal display device according to the present invention and the production method thereof will be described. However, the present invention is not limited to the following embodiments.

With reference to FIG. 1 and FIG. 2, an embodiment of the liquid crystal display device according to the present invention will be described. FIG. 1 shows a schematic diagram of the liquid crystal display device 100 of the present embodiment. The liquid crystal display device 100 includes a first substrate 110 having first electrodes 114 provided on an insulative substrate 112, a second substrate 120 having a second electrode 124 provided on an insulative substrate 122, and a liquid crystal layer 130 provided between the first electrodes 114 and the second electrode 124. The liquid crystal display device 100 further includes a backlight 160. On the outside of the insulative substrate 122 of the second substrate 120, a polarizing plate 150 is provided. The polarizing plate 150 is an iodine-type polarizing plate. The insulative substrates 112 and 122 are transparent glass substrates, for example. The liquid crystal display device 100 is a transmission type or a transmission/reflection combination type.

Herein, the first substrate 110 is an active matrix substrate (TFT substrate), and the first electrodes 114 are pixel electrodes. Although not shown in FIG. 1, wiring lines, switching elements (e.g., thin film transistors (TFTs)), and the like are provided on the insulative substrate 112. Herein, the second substrate 120 is a counter substrate, and the second electrode 124 is a counter electrode. On the insulative substrate 122, a black matrix 125, a color filter layer 126, and an alignment film 128 are provided. In the following description, the first electrodes 114 may be referred to as the pixel electrodes 114, whereas the second electrode 124 may be referred to as the counter electrode 124.

In the liquid crystal display device 100, pixels which are arranged in a matrix array of a plurality of rows and a plurality of columns are provided. The pixels are defined by the pixel electrodes 114, and the pixel electrodes 114 are arrayed in x and y directions.

FIG. 2(a) shows a schematic perspective view of the active matrix substrate 110 of the liquid crystal display device 100, and FIG. 2(b) shows a schematic cross-sectional view of the active matrix substrate 110 of the liquid crystal display device 100. FIG. 2(b) corresponds to a cross section along line 2b-2b′ in FIG. 2(a).

Each pixel electrode 114 is surrounded by two gate lines G and two source lines S. A gate of each TFT 115 is electrically connected to a gate line G, whereas a source of each TFT 115 is electrically connected to a source line S. Moreover, a drain of each TFT 115 is electrically connected to a pixel electrode 114. For example, the length of a pixel electrode 114 along the x direction is 63.5 μm, and its length along the y direction is 190.5 μm.

Each pixel electrode 114 includes a plurality of metal wires 114m extending linearly and in parallel to one another. The metal wires 114m are made of a metal material, e.g., aluminum. Alternatively, the metal wires 114m may be made of gold, silver, or copper. Thus, it is preferable that the metal wires 114m are made of a material showing a high electrical mobility and a high surface reflection rate. The plurality of metal wires 114m are electrically connected. The pixel electrodes 114 have an outer edge portion 114s which is continuous with the plurality of metal wires 114m. The outer edge portion 114s surrounds the metal wires 114m, and defines an outer edge of the pixel electrode 114. The outer edge portion 114s is made of the same material as the metal wires 114m.

The potentials of the plurality of metal wires 114m within one pixel electrode 114 are equivalent with one another. A pitch P of the metal wires 114m is 300 nm or less; a ratio KW/P) of a width W of the metal wires 114m to the pitch P of the metal wires 114m is in the range from 0.1 to 0.75; and a height H of the metal wires 114m is in the range from 50 nm to 500 nm. So long as the fabrication limits permit, it is preferable that the pitch of the metal wires 114m is as small as possible. For example, the pitch P, the width W, and the height H of the metal wires 114m are 200 nm, 50 nm, and 100 nm, respectively.

The pixel electrodes 114 have a wire grid structure, so that the pixel electrodes 114 function as a polarizer. A polarization component whose polarization direction is orthogonal to the direction that the metal wires 114m extend is transmitted through the pixel electrodes 114, whereas a polarization component whose polarization direction is parallel to the direction that the metal wires 114m extend is reflected by the pixel electrodes 114. Note that the transmittance (parallel transmittance, single transmittance) of the pixel electrodes 114 is no less than 10% and no more than 75%, whereas the reflectance of the pixel electrodes 114 is no less than 25% and no more than 90%. Thus, the pixel electrodes 114 have transmission axes which are orthogonal to the direction that the metal wires 114m extend. The pixel electrodes 114 are formed by depositing a metal material and thereafter patterning it. Moreover, the pixel electrodes 114 may be formed by a nanoimprint technique, a double beam interference exposure technique, or the like.

From a microscopic point of view, it might seem that an oblique electric field would occur because recesses are formed in the pixel electrodes 114. However, in actuality, the recesses of the pixel electrodes 114 are sufficiently small relative to the liquid crystal molecules 132, and therefore no oblique electric field that defines the orientation directions of the liquid crystal molecules 132 will substantially occur. If any oblique electric field occurs that defines the orientation directions of the liquid crystal molecules 132, it will cause disclination, and thus an alignment film (not shown in FIG. 1) should preferably be formed on the metal wires 114m.

Moreover, the counter electrode 124 has a flat surface, and opposes each of the plurality of pixel electrodes 114. Note that the counter electrode 124 is made a transparent electrically conductive material, e.g., indium tin oxide (ITO).

In the liquid crystal display device 100 of the present embodiment, the pixel electrodes 114 functioning as a polarizer are provided on the inside of the insulative substrate 112. Therefore, there is no need to separately provide a polarizing plate in addition to the pixel electrodes 114, and there is no need to attach a polarizing plate on the outside of the insulative substrate 112. Moreover, since the distance between the pixel electrodes 114 having a wire grid structure and the polarizing plate 150 is short and there are few members between the pixel electrodes 114 and the polarizing plate 150, fluctuations in the polarization state of light traveling through the polarizer can be suppressed, whereby the transmittance and contrast ratio can be improved.

Moreover, as described above, the liquid crystal display device 100 is of a transmission type or a transmission/reflection combination type, and the liquid crystal display device 100 includes the backlight 160. Therefore, light which is reflected by the metal wires 114m is reflected by the backlight 160 toward the metal wires 114m, thus improving the efficiency of light utilization.

Thus, since the pixel electrodes 114 of the active matrix substrate 110 function as a polarizer, there is no need to separately provide a polarizing plate on the active matrix substrate 110 in addition to the pixel electrodes 114. The fact that the pixel electrodes 114 have the metal wires 114m can be confirmed by using a microscope.

Note that the polarizing plate 150 is disposed so that its transmission axis is parallel to the direction that the metal wires 114m of the pixel electrodes 114 extend. As described above, the transmission axes of the pixel electrodes 114 functioning as a polarizer are in a direction which is orthogonal to the direction that the metal wires 114m extend, and the transmission axes of the pixel ‘electrodes 114 are in crossed Nicols relationship with the transmission axis of the polarizing plate 150.

The metal wires 114m of the pixel electrodes 114 as such are formed by patterning. Generally speaking, pixel electrodes are formed by depositing a transparent electrically conductive material and thereafter conducting a patterning through etching away the portions between adjoining pixel electrodes, etc. During this patterning, by removing the oblique linear portions within the outer edge portion 114s while leaving the outer edge portion 114s, mutually isolated metal wires 114m can be formed in the pixel electrodes 114 of the liquid crystal display device 100 of the present embodiment. Thus, the pixel electrodes 114 can be formed without particularly complicating the formation steps of the pixel electrode, thereby making it possible to omit a step of forming or a step of attaching a polarizing plate.

The liquid crystal display device 100 operates in the TN (Twisted Nematic) mode, and the liquid crystal layer 130 contains a liquid crystal material having a positive anisotropy of dielectric constant. In the case where the pitch of the metal wires 114m is small, in the absence of an applied voltage, the liquid crystal molecules 132 near the pixel electrodes 114 are oriented in parallel to the direction that the metal wires 114m of the pixel electrodes 114 extend. Thus, the pixel electrodes 114 function also as an alignment film. Note that the direction that the metal wires 114m extend intersects the x direction and the y direction at 45°. Moreover, the alignment film 128 is subjected to an alignment treatment in a direction which is orthogonal to the direction that the metal wires 124m extend. The alignment treatment is a rubbing treatment or a photo-alignment treatment, for example.

In the case where the voltage applied to the liquid crystal layer 130 is low, the liquid crystal molecules 132 near the alignment film 128 are oriented in parallel to the alignment treatment direction of the alignment film 128, whereas the liquid crystal molecules 132 near the pixel electrodes 114 are oriented in parallel to the direction that the metal wires 114m of the pixel electrodes 114 extend. Therefore, the liquid crystal molecules 132 take a twist alignment. In the case where the voltage applied to t liquid crystal layer 130 is high, the liquid crystal molecules 132 are oriented substantially in parallel to the normal directions of the principal faces of the pixel electrodes 114 and the alignment film 128.

Although the above description illustrates that the pixel electrodes 114 include the metal wires 114m, the present invention is not limited thereto. The counter electrode 124 may include a plurality of metal wires extending linearly and in parallel to one another. With reference to FIG. 3, a liquid crystal display device 100A will be described. FIG. 3(a) shows a schematic diagram of the liquid crystal display device 100A, and FIG. 3(b) shows a schematic plan view of a counter electrode 124 of the liquid crystal display device 100A.

In the liquid crystal display device 100A, the counter electrode 124 includes a plurality of metal wires 124m extending linearly and in parallel to one another, and an outer edge portion 124s which is continuous with the metal wires 124m. The pitch, width, and height of the metal wires 124m are 200 nm, 50 nm, and 100 nm, for example. The outer edge portion 124s is provided so as to correspond to the outer edge of the display region of the liquid crystal display device 100A.

Alternatively, as shown in FIG. 3(c), the metal wires 124m of the counter electrode 124 of the liquid crystal display device 100A may be made continuous not only via the outer edge portion 124s but also via pixel outer edge portions 124p which are provided corresponding to the pixel electrodes 114. In the case where there is a large influence of oblique electric fields due to the wiring lines of the pixel outer edge portions 124p, such influence can be suppressed by adopting the construction shown in FIG. 3(b). On the other hand, when there are relatively frequent instances of wire breaking, adopting the construction shown in FIG. 3(c) makes it possible to supply a counter signal to broken wires via the pixel outer edge portions 124p, thus improving the production yield.

An alignment film 118 and a polarizing plate 140 are provided on the insulative substrate 112 of the liquid crystal display device 100A, such that the transmission axis of the polarizing plate 140 is parallel to the direction that the metal wires 124m of the counter electrode 124 extend. Note that the liquid crystal display device 100A may be a transmission type or a transmission/reflection combination type, or alternatively a reflection type.

Although the above description illustrates that either the pixel electrodes 114 or the counter electrode 124 includes the metal wires 114m or the metal wires 124m, the present invention is not limited thereto. Both of the pixel electrodes 114 and the counter electrode 124 may include the metal wires 114m and 124m. With reference to FIG. 4 and FIG. 5, a liquid crystal display device 100B will be described. FIG. 4(a) shows a schematic diagram of the liquid crystal display device 100B; FIG. 4(b) shows a schematic plan view of pixel electrodes 114 of the liquid crystal display device 100B; and FIG. 4(c) shows a schematic plan view of a counter electrode 124 of the liquid crystal display device 100B. In the liquid crystal display device 100B, the pixel electrodes 114 and the counter electrode 124 respectively include metal wires 114m and 124m, such that the direction that the metal wires 114m of the pixel electrodes 114 extend is orthogonal to the direction that the metal wires 124m of the counter electrode 124 extend.

The liquid crystal display device 100B operates in the TN mode, such that orientation azimuth directions of the liquid crystal molecules 132 of the liquid crystal layer 130 are twisted by 90° along the thickness direction of the liquid crystal layer 130, as shown in FIG. 5. As a result, light entering the liquid crystal layer 130 undergoes optical rotation.

Although the above description illustrates that the metal wires 114m extend in one direction, the present invention is not limited thereto. The metal wires 114m may extend in a plurality of directions. With reference to FIG. 6, a liquid crystal display device 100C will be described.

As shown in FIG. 6(a), in the liquid crystal display device 100C, the metal wires 114m of a pixel electrode 114 include: metal wires 114m1 extending in parallel to the 135°-315° direction; metal wires 114m2 extending in parallel to the 45°-225° direction; metal wires 114m3 extending in parallel to the 135°-315° direction; and metal wires 114m4 extending in parallel to the 45°-225° direction. The metal wires 114m1 are continuous with the metal wires 114m2 and 114m4, and the metal wires 114m3 are continuous with the metal wires 114m2 and 114m4. The pixel electrode 114 further includes an outer edge portion 114s which is continuous with the metal wires 114m1 to 114m4.

As shown in FIG. 6(b), the metal wires 124m of the counter electrode 124 include: metal wires 124m1 extending along the 45°-225° direction; metal wires 124m2 extending along the 135°-315° direction; metal wires 124m3 extending along the 45°-225° direction; and metal wires 124m4 extending along the 135°-315° direction. The metal wires 124m1 are continuous with the metal wires 124m2 and 124m4, and the metal wires 124m3 are continuous with the metal wires 124m2 and 124m4. The metal wires 124m1 to 124m4 of the counter electrode 124 define rectangular lines surrounding the center of the pixel.

The counter electrode 124 further includes pixel outer edge portions 124p and a contact portion 124c. The contact portion 124c extends along the x direction so as to pass through the center of the pixel. Alternatively, the contact portion 124c may extend along the y direction so as to pass through the center of the pixel, or extend along both of the x direction and the y direction so as to pass through the center of the pixel. The pixel outer edge portions 124p and the contact portion 124c respectively realize electrical connection of the metal wires 124m1 to 124m4. The metal wires 124m1 to 124m4 of the counter electrode 124 respectively correspond to the metal wires 114m1 to 114m4 of the pixel electrode 114, such that the metal wires 124m1 to 124m4 extend in directions which are orthogonal to the metal wires 114m1 to 114m4.

As will be understood from FIG. 6(a) to FIG. 6(c), in the liquid crystal layer 130 of the liquid crystal display device 100C, a liquid crystal domain D1 is formed between the metal wires 114m1 of the pixel electrode 114 and the metal wires 124m1 of the counter electrode 124, whereas a liquid crystal domain D2 is formed between the metal wires 114m2 of the pixel electrode 114 and the metal wires 124m2 of the counter electrode 124. Similarly, in the liquid crystal layer 130, a liquid crystal domain D3 is formed between the metal wires 114m3 of the pixel electrode 114 and the metal wires 124m3 of the counter electrode 124, whereas a liquid crystal domain D4 is formed between the metal wires 114m4 of the pixel electrode 114 and the metal wires 124m4 of the counter electrode 124.

Now, the orientation directions of the liquid crystal molecules 132 in the liquid crystal display device 100C will be discussed. In the present specification, the orientation direction of a liquid crystal molecule in the center of a liquid crystal domain is referred to as a reference orientation direction; and within the reference orientation direction, an azimuth angle component in a direction from the rear face toward the front face and along the major axis of the liquid crystal molecule (i.e., an azimuth angle component obtained by projecting the reference orientation direction onto the principal face of an alignment film) is referred to as a reference orientation azimuth direction. The reference orientation azimuth direction characterizes its corresponding liquid crystal domain, and exerts a predominant influence on the viewing angle characteristics of that liquid crystal domain.

In the liquid crystal layer 130, the liquid crystal molecules 132 that are closer to the active matrix substrate 110 are oriented toward the neighborhood of the center of the pixel electrode 114, in accordance with an oblique electric field caused by the outer edge portion 114s. FIG. 6(c) shows the orientation azimuth directions of the liquid crystal molecules 132 in the liquid crystal domains D1 to D4, respectively as L1 to L4, that are closer to the active matrix substrate 110. Note that each of the orientation azimuth directions L1 to L4 represents an azimuth angle component in the direction from the rear face toward the front face.

On the other hand, in the liquid crystal layer 130, the liquid crystal molecules 132 that are closer to the counter substrate 120 are oriented in accordance with oblique electric fields caused by the pixel outer edge portions 124p. FIG. 6(c) shows the orientation azimuth directions of the liquid crystal molecules 132 in the liquid crystal domains D1 to D4, respectively as U1 to U4, that are closer to the counter substrate 120. Again, each of the orientation azimuth directions U1 to U4 represents an azimuth angle component in the direction from the rear face toward the front face. Herein, since the length of the pixel along the y direction is greater than its length along the x direction, the liquid crystal molecules 132 closer to the counter substrate 120 are oriented so as to have a component heading from the pixel center in the ±x direction.

The reference orientation azimuth directions of the liquid crystal domains D1 to D4 are intermediate azimuth directions between the orientation azimuth directions of the liquid crystal molecules 132 closer to the active matrix substrate 110 and the orientation azimuth directions of the liquid crystal molecules 132 closer to the counter substrate 120. FIG. 6(c) shows reference orientation azimuth directions R1 to R4 corresponding to the liquid crystal domains D1 to D4 in the liquid crystal display device 100C. The reference orientation azimuth directions R1 and R2 are set so as to differ by 180° from the reference orientation azimuth directions R3 and R4, thus improving the viewing angle characteristics.

Although the above description illustrates that the liquid crystal display device operates in the TN mode, the present invention is not limited thereto. The liquid crystal display device may operate in the STN (Super Twisted Nematic) mode.

Alternatively, the liquid crystal display device 100D may operate in the OCB (Optically Compensated Birefringence) mode, as shown in FIG. 7. In this case, the directions that the metal wires composing the pixel electrodes 114 extend are parallel to the directions that the metal wires composing the counter electrode 124 extend.

As described above, the present invention is applicable to liquid crystal display devices of various modes. However, in order to allow the electrodes to function as a polarizer, it is preferable that no wide slits e.g., with a width of 2 μm or more) are formed in the electrodes.

Note that the disclosure of Japanese Patent Application No. 2008-211004, which is a base application of the present application, is incorporated in the present specification by reference.

### INDUSTRIAL APPLICABILITY

According to the present invention, a liquid crystal display device which can be easily produced is provided.

### Reference Signs List

100 liquid crystal display device

110 active matrix substrate

112 insulative substrate

114 pixel electrode

120 counter substrate

122 insulative substrate

124 counter electrode

1. A liquid crystal display device comprising:
a first substrate having a first electrode;
a second substrate having a second electrode; and
a liquid crystal layer provided between the first electrode and the second electrode, wherein,
at least one of the first electrode and the second electrode includes a plurality of metal wires extending linearly and in parallel to one another wherein
each of the first electrode and the second electrode includes a plurality of metal wires extending linearly and in parallel to one another, and wherein
a direction that the plurality of metal wires of the first electrode extend is orthogonal to a direction that the plurality of metal wires of the second electrode extend.

2. The liquid crystal display device of claim 1, wherein the at least one electrode further includes an outer edge portion which is continuous with each of the plurality of metal wires.

3. The liquid crystal display device of claim 1, wherein the plurality of metal wires have a pitch of 300 nm or less; a ratio of a width of the plurality of metal wires to the pitch of the plurality of metal wires is in the range from 0.1 to 0.75; and the plurality of metal wires have a height in the range from 50 nm to 500 nm.

4. (canceled)

5. (canceled)
